(19) United States
(12) Patent Application Publication
(10) Pub. No.: US 2014/0268667 A1
(43) Pub. Date: Sep. 18, 2014

(54) SUCTION-ATTACHED WATER LAMP

(71) Applicant: CHIN-SHENG YANG, Tainan City (TW)

(72) Inventor: CHIN-SHENG YANG, Tainan City (TW)

(21) Appl. No.: 13/802,750

(22) Filed: Mar. 14, 2013

(51) Int. Cl. F21V 21/092; F21V 21/096

(52) U.S. Cl. CPC F21V 21/092; F21V 21/096
USPC 362/101

(57) ABSTRACT

The present invention is related to a suction-attached water lamp, which includes a translucent water lamp and a suction component. The translucent water lamp is a transparent stereoscopic model filled with a flowable liquid. The suction component is located at the rear side of the suction-attached water lamp. In this way, the suction-attached water lamp can be suction-attached to a smooth plate to achieve a decorative role.

### (a) TECHNICAL FIELD OF THE INVENTION

The present invention generally relates to water lamps, and more particularly to a water lamp that can be suction-attached to a metal plate to provide lighting effects.

### (b) DESCRIPTION OF THE PRIOR ART

Generally, except for the lamps that light up the environment at home, there are several decorative lightings that can be seen in the living room and bedroom, and this type of lighting mainly lights up small part of local space or embellishments as a decoration to increase the environmental atmosphere. However, those decorations are beautiful views of static functions. Therefore, there is a design of water lamps which has internal bright chips, bright powders or decorations, making the internal bright chips, bright powders or decorations generating the liquid flowing visual experience by using manual inverted shaking or electricity, because the water lamps internal objects are different, the visual effects are different, so that it has space for expansion and the effect of extending a variety of visual changes or the development of versatility and interesting, but it is limited to do more designs and changes in the part of water polo. Therefore, the development of this type of lighting is limited. Accordingly, if the water polo lighting which has the function of decoration and lighting can be combined with the advantages of interesting efficacy or breakthrough appearance visual of the other parts, it is surely more favored by the general public.

### SUMMARY OF THE INVENTION

According to above description, the present invention is to provide a water lamp decoration that allows a user to suction-attach the water lamp to a flat metal plate in order to increase the interesting of the product.

Accordingly, the present invention is related to a suction-attached water lamp, mainly comprising a translucent water lamp and a suction component, wherein the translucent water lamp is a transparent stereoscopic model that is filled with a flowable liquid and the suction component is located at the rear side of the suction-attached water lamp. In this way, it makes the suction-attached water lamp to be attached to a smooth plate to achieve a decorative role.

As mentioned above, the present invention combines the water lamp with suction components, wherein the suction components can be attached to a flat metal plate, such as a refrigerator, a message board, and an iron gate so that the water lamp can be placed on a plane and can increase interesting and usability.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a stereoscopic exploded schematic diagram of the present invention.

FIG. 2 is a stereoscopic diagram of the present invention.

FIG. 3 is a sectional view of the present invention.

FIG. 4 is an adsorbing on the metal plate schematic diagram of the present invention.

FIG. 5 is an absorbing on the refrigerator schematic diagram of the present invention.

FIG. 6 is a touch module schematic diagram of the present invention.

FIG. 7 is a connector embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

Referring to FIGS. 1 and 2, which are a stereoscopic exploded schematic diagram and an appearance diagram, the suction-attached water lamp of the present invention mainly comprises a translucent water lamp 1 and a suction component 2. The appearance of the translucent water lamp 1 is a transparent stereoscopic model, in which a flowing liquid is filled. The flowing liquid can be added bright chips and bright powders. The instant embodiment takes a snowman's head as an example, but this is not to limit the shape. The suction component 2 is provided on the rear side of the water lamp, and is, in this embodiment, a strong magnet. Thus, the translucent water lamp 1 can be suction-attached to a flat metal plate 3 (see FIG. 4) in order to be decoration.

As shown in FIG. 6, in this embodiment, the present invention further comprises a touch module 4 and a connector 5. The touch module 4 is a seat body provided with a power supply unit 41, a micro-switch 42, a central control unit 43, and a light emitting element 44. The connector 5 is a seat body of hollow stereoscopic shape, on its one end connects with the translucent water lamp 1. The hollow space receives therein the touch module 4. In this embodiment, the connector 5 takes the shape of the hat as an example, which connects to the top of the translucent water lamp 1.

As mentioned above, the power supply unit 41 is designed for mercury batteries to reduce the size. The micro-switch 42 can sense the slight movement to turn on the switch. The central control unit 43 is designed for intermittent starting or selective starting. The light emitting element 44 can be a light emitting diode and is set in direction toward the translucent water lamp 1.

Accordingly, when sensing a picking action, the micro-switch 42 commands the touch module 4 starting the light emitting element 44, to transmit the light of the light emitting element 44 to the translucent water lamp 1, and to achieve the decorative effect. FIG. 5 shows the present invention is attached to a refrigerator.

As shown in FIG. 3, during assembly of the present invention, the touch module 4 are formed to receive therein the power supply unit 41, the micro-switch 42, the central control unit 43 and the light emitting element 44, and is mounted to the connector 5. A liquid with low liquidity is filled in the translucent water lamp 1, and the light-emitting element 44 is provided in a direction corresponding to the translucent water lamp 1. The connector 5 houses the touch module 4 and is attached to the outside of the translucent water lamp 1.

When a user touches the present invention, the slight touching can make the micro-switch 42 starting the central control unit 43 and the light emitting element 44, allowing the light of the light emitting element 44 to pass through the translucent water lamp 1 to add the gorgeous effect.

As shown in FIG. 7, which shows another embodiment of the connector in the present invention, the connector 5 is formed as a cone and is connected to the bottom of the translucent water lamp 1. The translucent water lamp 1 is a sphere which has drawings and greetings inside of it, and there is a ring 6 provided above the sphere, making the present invention a decoration that can be suspended, besides being suction-attached.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An suction-attached water lamp, comprising a translucent water lamp and an suction component, said translucent water lamp being a transparent stereoscopic model filled with a flowable liquid, said suction component being located at rear side of the suction-attached water lamp, whereby said suction-attached water lamp is suction-attached to a smooth plate to achieve a decorative role.

2. The suction-attached water lamp according to claim 1 further comprising a touch module and a connector, said touch module being a seat body which comprises a micro-switch that selectively turn on a power supply to activate the light-emitting element to emit light, said connector being a hollow seat body having an end coupled to the suction-attached water lamp and forming a hollow space to receive therein the touch module.

3. The suction-attached water lamp according to claim 1, wherein said suction component is a magnet.
